(19) United States
(12) Patent Application Publication
(10) Pub. No.: US 2004/0004333 A1
(43) Pub. Date: Jan. 8, 2004

(54) Adjustable cargo hauler

(76) Inventor: Fred Riermann, New Richmond, WI (US)

Correspondence Address: Carl L. Johnson, Jacobson and Johnson, Suite 285, One West Water Street, St. Paul, MN, 55107-2080, US

(21) Appl. No.: 10/188,118

(22) Filed: Jul. 3, 2002

(51) Int. Cl. B62D 61/00

(52) U.S. Cl. 280/43.17

(57) ABSTRACT

A cargo hauler having a bed that can be lowered from a first position to a second position to facilitate the loading and unloading of cargo comprising a cargo bed, a set of wheels supporting the cargo bed, a U-shaped axle, U-shaped axle having a first end and a second end with the set of wheels attached proximate to the ends of the axle and a power source for moving the cargo bed between a cargo transporting condition and a cargo loading condition to aid in the loading and unloading of cargo.

### FIELD OF INVENTION

The present invention relates to cargo hauler, and more specifically, to a towable trailer having a cargo bed that can be lowered from a first position to a second position to facilitate in the loading and unloading of cargo.

### BACKGROUND OF THE INVENTION

Trailers are known in the art. The use of trailers allows a user to extend the cargo transporting capacity of his or her vehicle. Trailers typically comprise a trailer frame having a cargo bed located thereon for supporting the cargo. The trailer frame is supported by a set of wheels, which maintains the trailer frame sufficiently high above ground surface to provide the trailer with sufficient surface clearance for transporting the cargo to the desired destination.

Due to the trailer frame being maintained sufficiently above the ground surface to provide for surface clearance, the loading and unloading of cargo from the cargo bed requires lifting articles onto the trailer. Although various types of gates or ramps have been used to assist loading and unloading of cargo from the cargo bed, gates or ramps are often cumbersome to use and must also be carried along with the cargo on the cargo bed, often times reducing the trailer's cargo carrying capacity.

### SUMMARY OF THE INVENTION

The present invention relates to cargo hauler, and more specifically, to a towable trailer having a cargo bed that can be lowered from a first position to a second position to facilitate the loading and unloading of cargo. Briefly, the present invention comprises a trailer having a first position for transporting cargo and a second position for loading and unloading cargo. The trailer includes a cargo bed for supporting cargo during transport, a set of wheels supporting the cargo bed, a U-shaped axle having a first end and a second end with the set of wheels attached proximal to the ends of the U-shaped axle and a power source for moving the cargo bed between the first position and the second position to facilitate in the loading and unloading of cargo from the cargo bed.

An advantage of the present invention is that displacing the wheels with respect to the cargo bed by moving the cargo bed from the first position to the second position (loading condition) forms a low-incline loading ramp to aid the user in the loading and unloading of cargo.

### BRIEF DESCRIPTION OF THE DRAWINGS

FIG. 1 shows a bottom view of a trailer of the present invention;

FIG. 2 shows a close-up top view of the first end of the U-shaped axle in the cargo loading condition;

FIG. 3 shows a close-up top view of the first end of the U-shaped axle in the cargo transporting condition;

FIG. 4 shows a close-up perspective view of the first end of the U-shaped axle in the cargo transporting condition;

FIG. 5 shows a close-up perspective view of the first end of the U-shaped axle in the cargo loading condition;

FIG. 6 shows a side view of a trailer in the cargo transporting condition;

FIG. 7 shows a side view of a trailer in a cargo loading condition;

FIG. 8 is a side view of a laterally slidable cargo rest; and

FIG. 9 is a rear view of a cargo bed with the cargo rest of FIG. 8 located thereon.

### DESCRIPTION OF THE PREFERRED EMBODIMENT

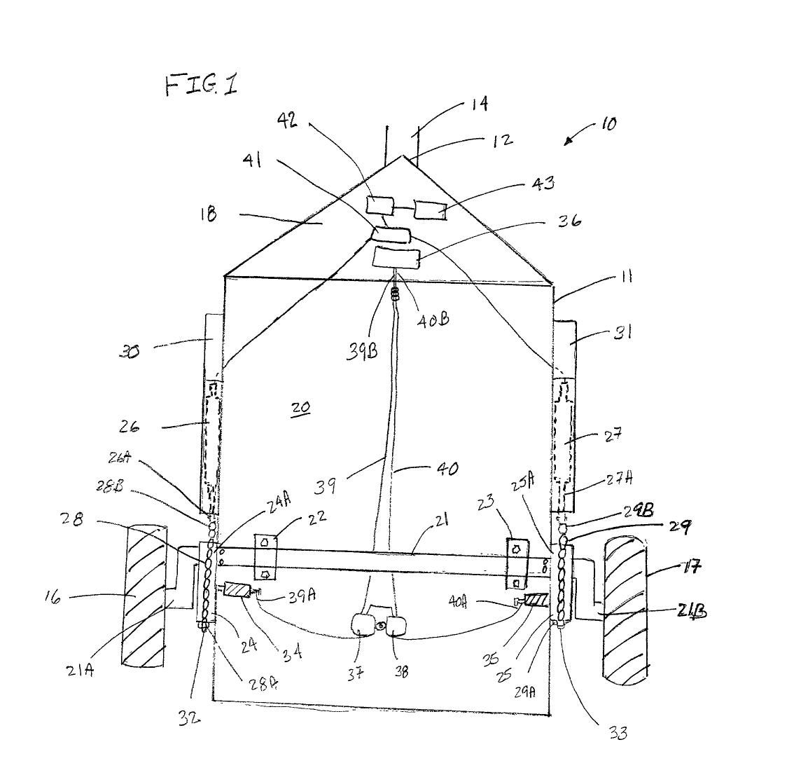

Referring to FIG. 1, reference numeral 10 identifies a towable trailer 10 that is moveable between a cargo transporting condition to a cargo loading condition in order to facilitate the loading and unloading of cargo. Reference numeral 11 identifies a trailer frame having a first end 12 and a second end 13. Second end 13 is also known as the loading end 13 of trailer 10. Securely attached to first end 12 of trailer frame 11 is a hitch 14 for attaching trailer 10 to a vehicle for towing.

Trailer 10 includes a U-shaped axle 21 attached to a bottom surface 20 of trailer frame 11 with U-shaped axle 21 having a first end 21A and a second end 21B. Although axle 21 is shown in the present embodiment as being rotatably mounted to bottom surface 20 by a first axle housing bracket 22 and a second axle housing bracket 23, axle 21 may be attached to trailer frame 11 by alternative means.

Free-rotatingly attached to the first end 21A of axle 21 is a wheel 16 and free-rotatingly attached to the second end 21B of axle 21 is a wheel 17. Wheels 16 and 17 function to support trailer frame 11 on a support surface such as a ground surface. Secured proximal to end 21A of axle 21 is an axle cam 24 having a groove 24A thereon for engaging a flexible member such as chain 28 and chain 29 and secured proximal to end 21B of axle 21 is an axle cam 25 having a groove 25A thereon also for engaging a flexible member such as chain 29.

The present invention also includes a device capable of generating a force for moving trailer 10 between the cargo transporting condition and the cargo loading condition. In the embodiment of FIG. 1, the device capable of generating a force comprises a first dual acting cylinder 26 having an extendable arm 26A and a second dual acting cylinder 27 having an extendable arm 27A. Cylinder 26 is housed in a first cylinder housing 30 and cylinder 27 is housed in a second cylinder housing 31. Although the present embodiment uses dual acting cylinders, single acting cylinders may also be used for moving trailer 10 between the cargo transporting condition and the cargo loading condition.

The present also includes a power source for powering cylinders 26 and 27. As shown in FIG. 1, the power source comprises a hydraulic pump 41, an electric motor 42, and a battery 43 located in a front compartment 18 of the trailer frame 11. Pump 41, motor 42 and battery 43 work to control the contracting and extending action of arm 26A of cylinder 26 and arm 27A of cylinder 27.

As shown in FIG. 1, connecting axle cam 24 to cylinder 26 is a first chain 28 having a first end 28A and a second end 28B. End 28A of chain 28 is secured to axle cam 24 by a pin 32 with a portion of chain 28 engaging groove 24A of axle cam 24 and end 28B of chain 28 is secured to arm 26A of cylinder 26.

Connecting axle cam 25 to cylinder 27 is a second chain 29 having a first end 29A and a second end 29B. End 29A of chain 29 is attached to axle cam 25 by a pin 33 in the same fashion as chain 28 with a portion of chain 29 engaging groove 25A of axle cam 25 and end 28B of chain 28 is attached to arm 27A of cylinder 27. Chains 28 and 29 allow cylinders 26 and 27 to engage axle cams 24 and 25. Although two cylinders are used in the present embodiment, alternative embodiments may use just one cylinders or a set of cylinder comprising of more than two cylinders to move trailer 10 between the cargo transporting condition and the cargo loading condition.

The present invention also includes the use of at least one locking pin to lock trailer 10 in the cargo transporting condition. The embodiment of FIG. 1 shows the locking pins comprising a first spring loaded locking pins 34 having a first end 34A and a second end 34B and a second spring loaded locking pin 35 having a first end 35A and a second pin 35B. As shown in FIG. 1, locking pin 34 is secured on trailer frame 11 sufficiently close to axle cam 24 so that first end 34A of pin 34 is able to engage with a slot located on axle cam 24 when trailer 10 is in the cargo transporting condition. Similarly, locking pin 35 is secured on trailer frame 11 sufficiently close to axle cam 25 so that first end 35A of pin 35 is also able to engage with a slot located on axle cam 25 when trailer 10 is in the cargo transporting condition.

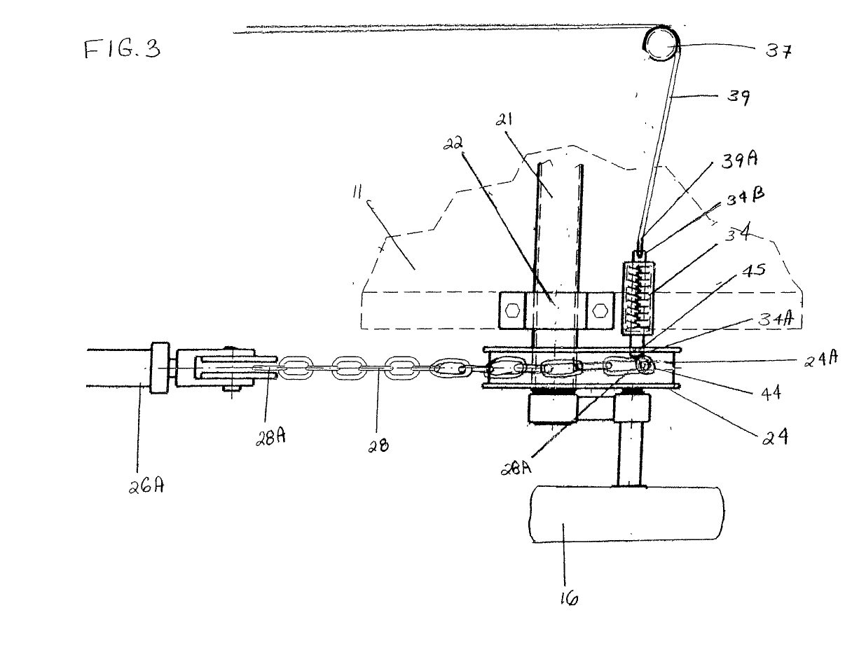

Referring to FIG. 3, in the cargo transporting condition, the engagement of locking pin 34 to a slot 45 located on axle cam 24 will prevent the rotation of axle cam 24 thereby preventing the rotation of axle 21. Since axle cam 24 and axle 21 cannot rotate, trailer 10 is locked in the cargo transporting condition and cannot move to the cargo loading condition until pin 34 is disengaged from slot 45.

Referring back to FIG. 1, although two locking pins are used to lock trailer 10 in the cargo transporting condition in the embodiment of FIG. 1, one locking pin may alternatively be used to locking trailer 10 in the cargo transporting condition.

In order to facilitate the conversion of the trailer 10 from the locked cargo transporting condition to the cargo loading condition, the present embodiment also includes an unlocking mechanism comprising a pulley lever 36; a first pulley wheel 37 and a second pulley wheel 38; and a set of flexible member such as a cable 39 having a first end 39A and a second end 39B and a cable 40 having a first end 40A and a second end 40B.

End 39A of cable 39 is secured to the second end 34B of locking pin 24 while end 39B of cable 39 is secure to pulley lever 36. Likewise, end 40A of cable 40 is secured to the second end 35B of locking pin 35 while end 40B of cable 40 is also secured to pulley lever 36 whereby a force directed on cables 39 and 40 by pulley lever 36 results in the disengagement of the locking pins 34 and 35 from the slots of axle cam 24 and axle cam 25 thereby unlocking trailer 10 from the cargo transporting condition. The unlocking of trailer 10 allows axle 21 and axle cam 24 to be rotatable so as to move trailer 10 from the cargo transporting condition to the cargo loading condition through the extending action of the cylinders.

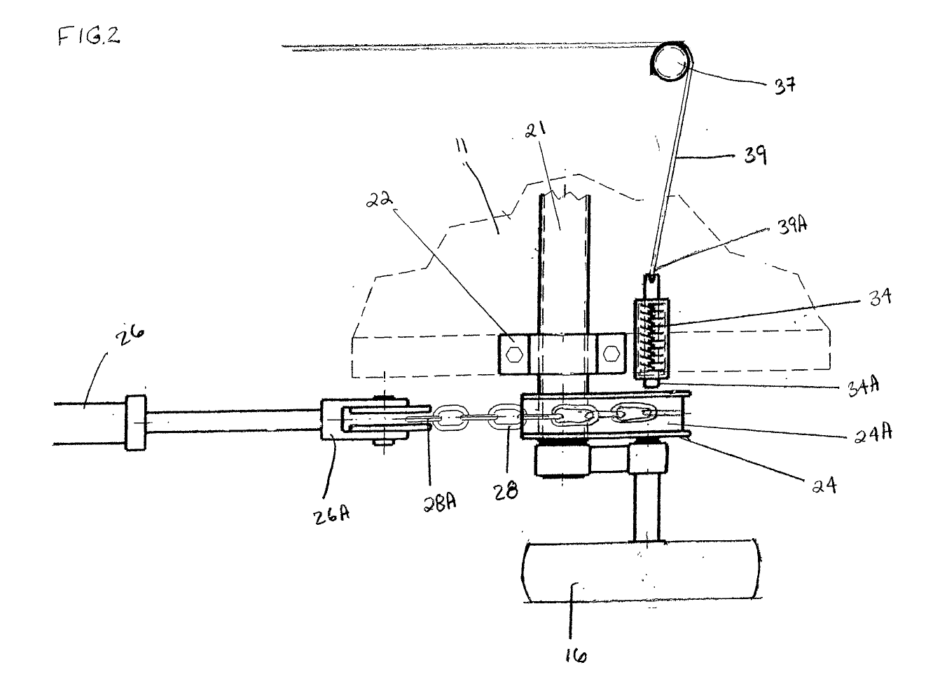

FIG. 2 and FIG. 3 both show a close-up top view of end 21A of axle 21 with FIG. 2 showing axle 21 in the cargo loading condition and FIG. 3 showing axle 21 in the locked cargo transporting condition. As shown in FIG. 2 and FIG. 3, end 28A of chain 28 is secured to axle cam 24 with a portion of chain 28 engaging the groove 24A of axle cam 24. The second end 28B of chain 28 is secured to arm 26A of cylinder 26. The cargo loading condition, as shown in FIG. 2, is characterized by the extension of arm 26A. In the cargo loading condition, since the first end 34 of locking pin 34 is not engaged to slot 45 of axle cam 24 (shown in FIG. 3), locking pin 34 does not hinder the movement or rotation of axle cam 24.

Referring to FIG. 3, the cargo transporting condition is characterized by the contraction of arm 26A of cylinder 26. In the cargo transporting condition of FIG. 3 the first end 34A of locking pin 34 is engaged with slot 45 of axle cam 24. The engagement of locking pin 34 to slot 45 results in the locking of cam 24 and axle 21 in the cargo transporting condition, preventing the movement of trailer frame 11 to the cargo loading condition.

In the operation of moving trailer 10 from the cargo loading condition to the cargo transporting condition, motor 42 and hydraulic pump 41 (shown in FIG. 1) powers arm 26A of cylinder 26 to contract, creating a force directed on chain 28. The force causes axle cam 24 to rotate, which in turn causes the rotation of U-shaped axle 21 to move trailer 10 from the cargo loading condition. Axle 21 will continue to rotate from the cargo loading condition until either arm 26A of the cylinder 26 stop contracting or until axle 21 arrives at the cargo transporting condition. Once trailer 10 arrives at the cargo transporting condition, rotation of U-shaped axle 21 will cease with cylinder 26 maintaining trailer 10 in the cargo transporting condition by cylinder 28's hold of axle cam 24 through chain 28. The cargo transporting condition provides trailer 10 with sufficient surface clearance to transport cargo to the desired destination.

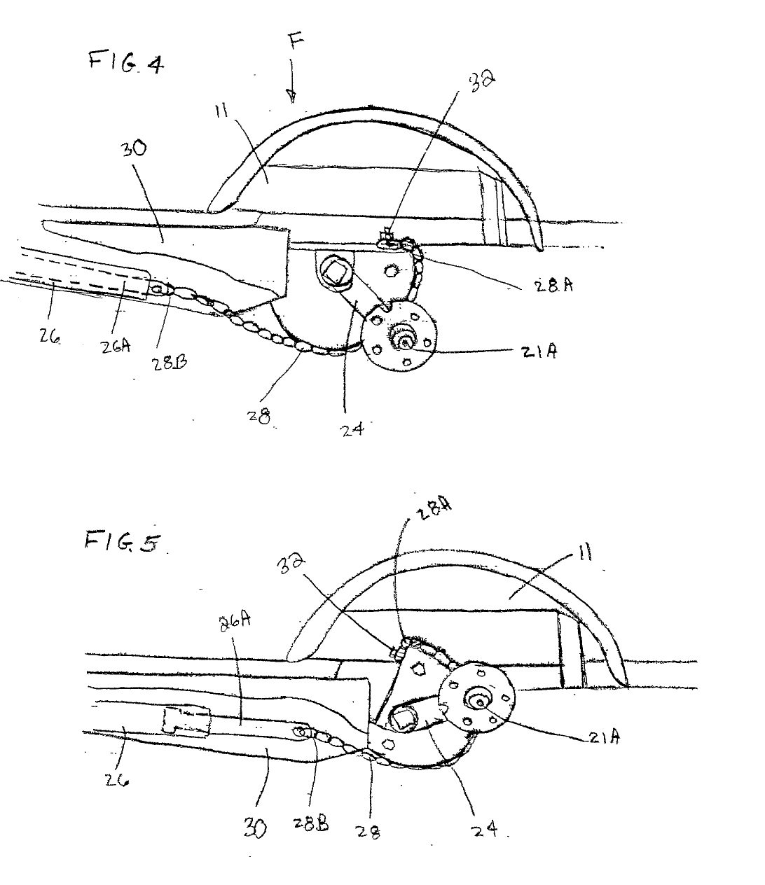

In the cargo transporting condition, a downward force F from the weight of the trailer (shown in FIG. 5) will be continuously acting on trailer 10 thereby placing force on cylinder 26 through axle cams 24 in maintaining trailer 10 in the cargo transporting condition. To eliminate the force that is placed on cylinders 26 and 27 by downward force F (shown in FIG. 5), once trailer 10 arrives at the cargo transporting condition the first end 34A of locking pin 34 engages with slot 45 to thereby lock axle cam 24 in the cargo transporting condition. Similarly, the first end 35A of locking pin 34 (shown in FIG. 1) also engages with the slot (not shown) located on axle cam 25 to thereby lock axle cam 25 in the cargo transporting condition. Locking axle cams 24 and 25 in the cargo transporting condition restricts axle 21 from moving back to the cargo loading condition thereby relieving part of the stress on pressure cylinders 26 and 27 resulting from their engagement of axle cams 24 and 25 through chain 28 and chain 29.

In the operation of moving the trailer 10 from the locked cargo transporting condition back to the cargo loading condition, a force is directed on cable 39 by pulley lever 36 which cause locking pin 34 to disengage from slot 45 of axle cam 24 and locking pin 35 to disengage from the slot of axle cam 25 (the slot of axle cam 25 is not shown) thereby unlocking trailer 10 from the cargo transporting condition. The extending action of arm 26A of cylinder 26 and arm 27A of cylinder 27 allows for the movement of axle cam 24 and axle cam 25 from the cargo transporting condition to the cargo loading condition thereby lowering the cargo bed closer to a support surface to facilitate the loading and unloading of cargo from the cargo bed.

Although pressure cylinders are used in the present embodiment to move trailer 10 between the cargo transporting condition and the cargo loading condition, alternative embodiments of the present invention may use other devices such as winches to move trailer 10 between the cargo transporting condition and the cargo loading condition.

FIGS. 4 and 5 show a close-up perspective view of end 21A of axle 21 (without wheel 16) with FIG. 4 showing axle 21 (without wheel 16) in the cargo transporting condition and FIG. 5 showing axle 21 in the cargo loading condition. As shown in FIGS. 4 and 5, end 28A of chain 28 is secured to axle cam 24 by a pin 32 and the second end 28B of chain 28 is secured to the arm 26A of cylinder 26. Pressure cylinder 26 is shown located within a protective cylinder housing 30. The cargo transporting condition, as shown in FIG. 4, is characterized by end 21A of U-Shaped axle 21 located at a position vertically distal to trailer frame 11 with extendable arm 26A of cylinder 26 in a contracted condition. In the cargo transporting condition, a downward force F is continuously acting on trailer frame 11 to direct the movement of U-shaped axle 21 to the cargo loading condition. As shown in FIG. 5, movement of the U-shaped axle 21 from the cargo transporting condition to the cargo loading condition is achieved through the coacting of cylinder 26, axle cam 24, and chain 28.

In moving U-shaped axle 21 from the cargo transporting condition to the cargo loading condition, the extension of arm 26A of cylinder 26 (FIG. 4) allows downward force F to direct U-shaped axle 21 to rotate counter-clockwise thereby bringing trailer frame 11 closer to end 21A of U-shaped axle 21. As end 21A of U-shaped axle 21 moves closer to trailer frame 11 axle cam 24 will simultaneously rotate to further wrap chain 28 to grove 28A until trailer 10 reaches the cargo loading condition.

Although U-shaped axle 21 is used in the present embodiment, a normal or linear shaped axle may be used in an alternative embodiments of the present invention with axle cams secured to the ends of the axle and with wheels 16 and 17 free-rotatingly attached to the axle cams for supporting trailer frame 11 on the support surface.

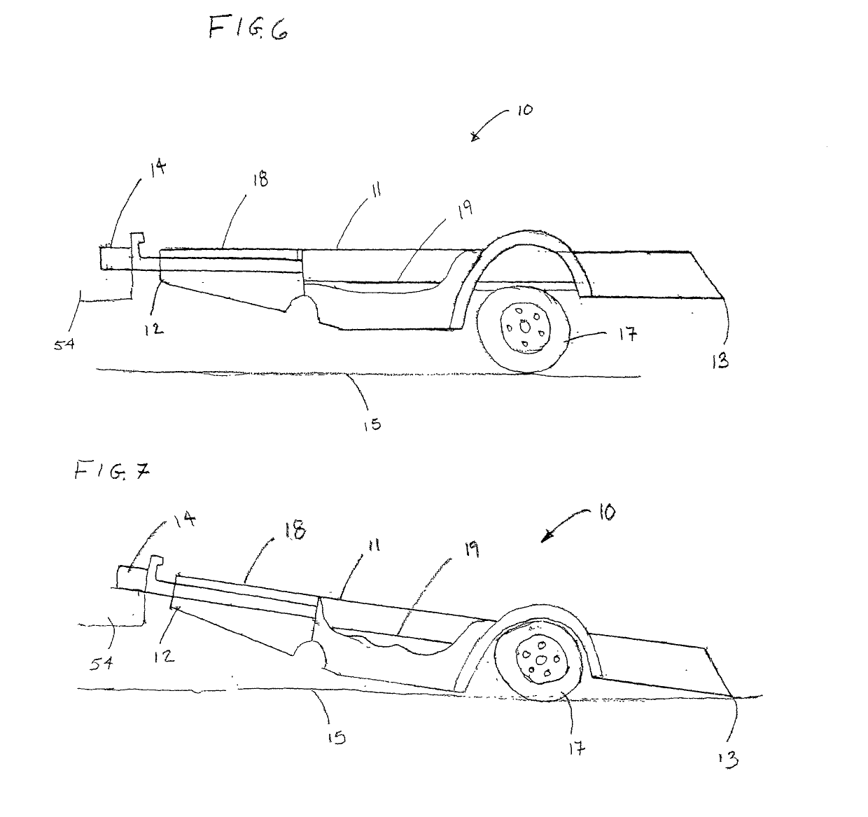

Referring to FIGS. 6 and 7, FIG. 6 and FIG. 7 are side views of trailer 10 with FIG. 6 shows trailer 10 in the cargo transporting condition and FIG. 7 shows trailer 10 in a cargo loading condition.

Referring to FIG. 6, as shown, located at end 12 of trailer frame 11 is hitch 14 for attaching trailer 10 to a vehicle 54. Supporting trailer frame 11 on a support surface such as ground surface 15 are wheels 16 (shown in FIG. 1) and 17. Located proximate the end 12 is front compartment 18 for housing the power source for powering the movement of trailer 10 between the cargo transporting condition and the cargo loading condition. Located between front compartment 18 and loading end 13 is a cargo bed 19 for supporting cargos to be transported thereon. As previously mentioned, FIG. 6 shows trailer 10 in the cargo transporting condition. The cargo transporting condition, as shown in FIG. 6, is defined as the position at which the loading end 13 is spaced from support surface 15.

Referring to FIG. 7, FIG. 7 shows trailer 10 in a cargo loading condition. As shown by FIGS. 6 and 7, as trailer 10 moves from the cargo transporting condition to the cargo loading condition trailer frame 11 moves vertically closer to support surface 15. In the cargo loading condition of FIG. 7 the loading end 13 is lower proximal to support surface 15 while the first end 12 remains hitched to vehicle 54 resulting in a pivoting of the cargo bed about hitch 14 which results in a shallow incline of cargo bed 19. Although cargo bed 19 is shown in FIG. 7 as being position at an incline, the angle of incline of cargo bed 19 is sufficiently shallow so as to allow for the ease of loading and unloading of cargo on cargo bed 19. That is, cargo bed 19 forms its own ramp that extends the length of the trailer.

Although the cargo loading condition of FIG. 7 shows cargo bed 19 at an incline resulting from the lowering of only loading end 13, alternative embodiment may include the uncoupling of hitch 14 and lowering of both first end 12 and loading end 13, thereby resulting in cargo bed 19 being in a linear position in the cargo loading condition. In the embodiment shown, trailer 10 includes a set of wheel. However, a trailer with a single wheel may also be used with my invention.

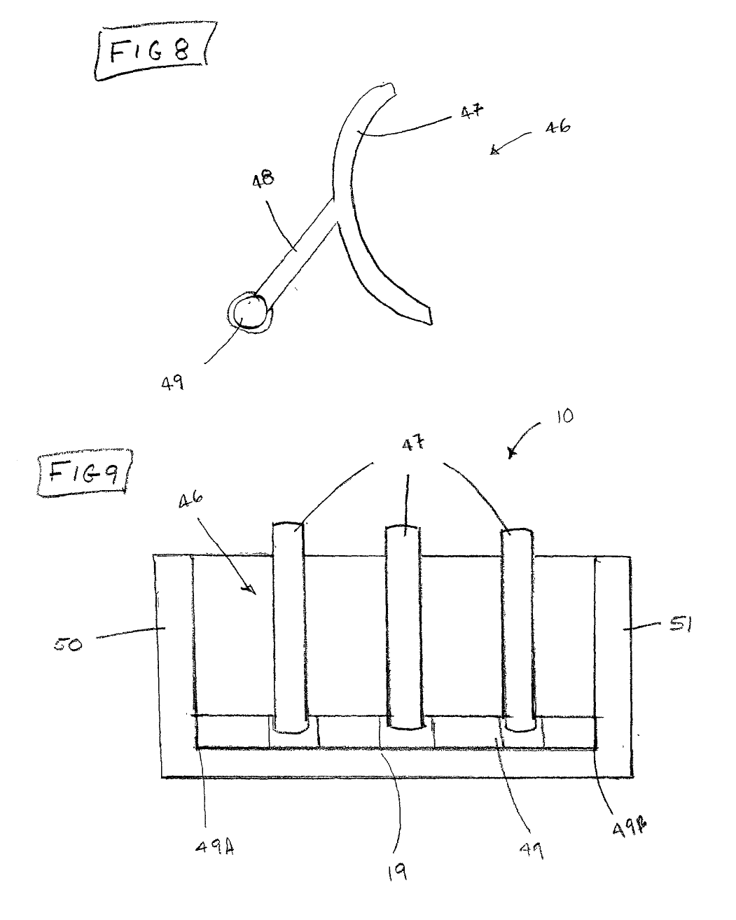

FIG. 8 is a side view of a laterally slidable cargo rest or stop 46 for engaging and supporting cargo such as bicycle, motorcycles, and RVs. Cargo rest 46 comprises a set of members 47 having necks 48 which slidably attaches the members 47 to a support bar 49 to permit lateral positioning of cargo rest 46. Support bar 49 includes a first end 49A and a second end 49B, which engages to the sides of cargo bed 19 to secure the supporting bar to cargo bed 19.

FIG. 9 shows a rear view of the cargo bed 19 of the trailer 10 having cargo rest 46 located thereon. In FIG. 9, first end 49A of support bar 49 is shown engaged to a first side 50 of trailer 10 and second end 49B of support bar 49 is shown engaged to a second side 51 of trailer 10. Engagement of support bar 49 to sides 50 and 51 allows for the securement of cargo rest 46 to cargo bed 19. As shown in FIG. 9, members 47 are laterally slidable along support bar 49 so as to allow the user to position the members along the support bar for support of cargo of varying sizes.

While the present invention is shown on a towable trailer, it is envision that cargo hauler, whether towable or self-powered could employ my invention.

I claim:

1. A cargo hauler having a first position for loading and a second position for transporting comprising:
a cargo bed; and
a wheel supporting said cargo bed; said cargo bed movable between a cargo transporting condition and a cargo loading condition to enable the loading and unloading of a cargo thereon.

2. The cargo hauler of claim 1 including a power source for moving said cargo bed between a cargo transporting condition and a cargo loading condition.

3. The cargo hauler of claim 1 including an U-shaped axle, said U-shaped axle having a first end and a second end with wheels thereon for supporting said cargo bed.

4. The cargo hauler of claim 1 including a cam whereby a rotation of said cam results in the movement of said cargo bed between the cargo transporting condition and the cargo loading condition to enable the loading and unloading of a cargo thereon.

5. The cargo hauler of claim 1 including a locking pin for locking said cargo bed in the cargo transporting condition.

6. The cargo hauler of claim 1 including a lifting device for moving said cargo bed between the cargo transporting condition and the cargo loading condition.

7. The cargo hauler of claim 1 including a pressure cylinder for moving said cargo bed between the cargo transporting condition and the cargo loading condition.

8. The cargo hauler of claim 1 wherein said cargo bed comprises a trailer frame, said trailer frame including a hitch for connecting said trailer frame to a vehicle

9. The cargo hauler of claim 1 including a cargo rest slidably adjustable along the cargo bed for securing the cargo thereon.

10. The cargo hauler of claim 3 including an axle cam securely attached to said axle and an axle cam rotating member, said axle cam rotating member having a first end and a second end, the first end of said axle cam rotating member secured to the axle cam and the second end of said axle cam rotating member secured to a force generating device whereby a force directed on said axle cam rotating member by said force generating device results in the rotation of said axle cam and said axle allowing for the movement of the cargo bed between the cargo transporting condition and the cargo loading condition to enable the loading and unloading of a cargo thereon.

11. The cargo hauler of claim 5 wherein said locking pin comprises a spring loaded locking pin.

12. The cargo hauler of claim 5 wherein said spring loaded locking pins includes an unlocking mechanism.

13. The cargo hauler of claim 7 including an electric motor, a battery, and a hydraulic pump for powering said cylinder.

14. The cargo hauler of claim 12 wherein said unlocking mechanism comprises:
a pulley lever;
a pulley; and
a flexible member, said first flexible member engaging the pulley, said flexible member having a first end and a second end; the first end of said flexible member secured to the second end of said spring loaded locking pin and the second end of said flexible member secured to said pulley lever whereby a force directed on said flexible member results in the disengagement of said locking pin from the slot of the first axle cam allowing for the movement of the cargo bed from a cargo transporting condition to a cargo loading condition.

15. A trailer having a first position for loading and a second position for transporting comprising:
a cargo bed;
at least one wheel for supporting said cargo bed, said at least one wheel displaceable with respect to said cargo bed; and
a power source for displacing said wheel for moving said cargo bed between a cargo transporting condition and a cargo loading condition.

16. The trailer of claim 15 including an axle cam securely attached to said axle and an axle cam rotating member, said axle cam rotating member having a first end and a second end, the first end of said axle cam rotating member secured to the axle cam and the second end of said axle cam rotating member secured to a force generating device whereby a force directed on said axle cam rotating member by said force generating device results in the rotation of said axle cam and said axle allowing for the movement of the cargo bed between the cargo transporting condition and the cargo loading condition to enable the loading and unloading of a cargo thereon.

17. The trailer of claim 15 wherein said power source is carried by said trailer to enable the movement of the cargo bed without an exterior power source.

18. The trailer of claim 15 including a locking pin for locking said cargo bed in the cargo transporting condition.

19. The trailer of claim 18 wherein said locking pin comprises a spring loaded locking pin.

20. The trailer of claim 19 wherein said spring loaded locking pins includes an unlocking mechanism comprising:
a pulley lever;
a pulley; and
a flexible member, said first flexible member engaging the pulley, said flexible member having a first end and a second end; the first end of said flexible member secured to the second end of said first spring loaded locking pin and the second end of said flexible member secured to said pulley lever whereby a force directed on said flexible member results in the disengagement of said locking pin allowing for the movement of the cargo bed from a cargo transporting condition to a cargo loading.
